(19) United States
(12) Patent Application Publication
(10) Pub. No.: US 2002/0049814 A1
(43) Pub. Date: Apr. 25, 2002

(54) System and method for book-marking a specific location in virtual space

(76) Inventor: Hwan Soo Yoo, Suwon (KR)

Correspondence Address: WILDMAN, HARROLD, ALLEN & DIXON, 225 WEST WACKER DRIVE, CHICAGO, IL, 60606, US

(21) Appl. No.: 09/945,067

(22) Filed: Aug. 31, 2001

(30) Foreign Application Priority Data
Aug. 31, 2000 (KR) 2000-50965

(51) Int. Cl. G06F 15/16; G09G 5/00

(52) U.S. Cl. 709/205; 345/744; 345/753; 463/42; 345/757

(57) ABSTRACT

A system and method for book-marking a particular location in virtual space are provided to book-mark static information only in the virtual space. Pieces of information such as a user ID, a location and a world ID are transmitted to a web server while book-marking. The web server transmits user's background screen by taking a single snapshot based on the received information. Furthermore, when returning to the user's original location, a web server browsing system interprets the information on the screen by taking the snapshot and transmits the same to a web server system. Therefore, the web server transmits a screen of the location based on the information so as to display the screen on the user's monitor of the web browsing system. Herein, the data includes not only the background screen but also all information on the current status at the location.

### FIELD OF THE INVENTION

The present invention relates to a system and method for book-marking a specific location in virtual space. More particularly, it relates to a system and method for book-marking static information only in virtual space.

### DESCRIPTION OF THE RELATED ART

Since the Internet has been used popularly and great numbers of Internet sites now exist, one can book-mark those sites useful and of interest, or sites that one may visit frequently in the future on a web browser. Microsoft Corp., for instance, supports in their web browsing software known as “Internet Explorer®” program so that a user can easily book-mark such sites. This refers to a book-marking system that a user can record the Uniform Resource Locator (URL) of the sites where the user have visited, at a web browser or the File Transfer Protocol (FTP) client so that one can re-call the URL next time and move thereto. This kind of function is commonly set as a subprogram at two-dimensional web browsers. The user can easily revisit previously visited sites, using the subprogram through a directory of the sites shown in the form of a list box or a tree diagram.

Meanwhile, users of the current Internet environment mostly use the two-dimensional user interface; now, however, a user-friendly three-dimensional interface is more required and related technologies thereof have become prominent.

The book-marking technologies in the two-dimensional web browsers are not available for book-marking a particular location within a three-dimensional virtual space or a four-dimensional space, which additionally contains the concept of time, but only available for the two-dimensional information such as the HyperText Transfer Protocol(HTTP) or FTP, i.e., useful for searching detailed text information only.

Especially with the two-dimensional information, only the URL corresponding to a screen of a desired site is stored at the web browser in order to use in book-marking. However, there exist at the three-dimensional virtual space, not only the background screen displaying imaged materials within a predetermined distance from the particular location in the virtual space, but also avatars or other time-limited objects, for example, all objects such as animals, vehicles, which have mobility in real world. Accordingly, if the user stores the background screen of the virtual space as it is, while book-marking the same, such time-limited objects having mobility can be seen on the monitor when the user re-calls the book-marked screen afterwards. The time-limited objects, however, may disappear from the actual book-marking location within the virtual space. This will be explained in detail hereinbelow.

A typical network employing the Internet is shown in FIG. 1. A plurality of users 1-5 access a web server 8 through a Local Area Network (LAN) 6 with the Internet 7, and the users navigate certain virtual spaces provided by the web server 8. Here, when the user 1, for instance, in course of navigation stores a screen as a thumbnail screen for that in order to book-mark a particular location at the virtual space, an avatar representing the user 1 and other avatars for user 2, user 3 and the like are all stored at that time. When the user 1 clicks the thumbnail screen in order to revisit the location later, other users' avatars actually disappear at the book-marking location in the virtual space and another users' avatars may exist. This may be unnecessary information for the user 1. Accordingly, while book-marking, it is required to store only static information for objects such as surroundings at a location where a user's avatar exists, except dynamic information, e.g., the time-limited objects having mobility.

### SUMMARY OF THE INVENTION

The present invention is provided to meet the requirements as described above, and also the object of the same is to provide an enhanced system and method for book-marking static information in virtual space.

The present invention provides according to the first embodiment thereof, a book-marking system on user's part for book-marking a particular location in a virtual space under the control of a server providing the virtual space on a network comprises: means for requesting to the server information required for book-marking through the network, when the user requests to book-mark for the particular location; wherein the information includes data for identifying the virtual space; data for indicating the particular location within the virtual space; and data on static objects except dynamic objects which vary with time within a predetermined distance from the particular location; and means for storing the information when the information is received from the server so as to provide the information to the user when the user requests later.

According to the second embodiment of the present invention, a book-marking system mounted to a server providing a virtual space on a network, for supporting a user to book-mark a particular location in the virtual space comprises: a first storage means for storing data of the user; a second storage means for storing data of the virtual space; and means for creating information of book-marking and transmitting the book-marking information to the user, after recognizing the particular location in the virtual space by using the user data and the virtual space data stored in the first and second storage means, when the user requests the information of book-marking the particular location, wherein the book-marking information includes data for identifying the virtual space; data for indicating the particular location within the virtual space; and data on static objects except dynamic objects which vary with time within a predetermined distance from the particular location.

According to the third embodiment of the present invention, a book-marking system to support a user to book-mark a particular location in a virtual space under the control of a server providing the virtual space on a network comprises: associated to user's part, means for requesting to the server information required for book-marking through the network, when the user requests to book-mark for the particular location; wherein the information includes data for identifying the virtual space; data for indicating the particular location within the virtual space; and data on static objects except dynamic objects which vary with time within a predetermined distance from the particular location; associated to the server, a first storage means for storing data on the user; associated to the server, a second storage means for storing data on the virtual space; associated to the server, means for creating information of book-marking and transmitting the book-marking information to the user, after recognizing a particular location in the virtual space by using the user data and the virtual space data stored in the first and second storage means, when the user requests the information of book-marking the particular location; and associated to user's part, means for storing the information when the information is received from the server so as to provide the information to the user when the user requests later.

According to the fourth embodiment of the present invention, a book-marking method on user's part for book-marking a particular location in a virtual space under the control of a server providing the virtual space on a network comprises the steps of: requesting to the server information required for book-marking through the network, when the user requests to book-mark the particular location, wherein the information includes data for identifying the virtual space; data for indicating the particular location within the virtual space; and data on static objects except dynamic objects which vary with time within a predetermined distance from the particular location; and storing the information, when the information is received from the server so as to provide the information to the user when the user requests later.

According to the fifth embodiment of the present invention, a book-marking method on server's part to support a user to book-mark a particular location in a virtual space comprises the steps of: storing data on the user; storing data on the virtual space; and creating information of book-marking and transmitting the book-marking information to the user, after recognizing the particular location in the virtual space by using the user data and the virtual space data, when the user requests the information of book-marking the particular location, wherein the book-marking information includes data for identifying the virtual space; data for indicating the particular location within the virtual space; and data on static objects except dynamic objects which vary with time within a predetermined distance from the particular location.

According to the sixth embodiment of the present invention, a book-marking method to support a user to book-mark a particular location in a virtual space under the control of a server providing the virtual space on a network comprises the steps of: on user's part, requesting to the server information required for book-marking through the network, when the user requests to book-mark for the particular location; wherein the information includes data for identifying the virtual space; data for indicating the particular location within the virtual space; and data on static objects except dynamic objects which vary with time within a predetermined distance from the particular location; on server's part, storing data on the user; on server's part, storing data on the virtual space; on server's part, creating information of book-marking and transmitting the book-marking information to the user, after recognizing a particular location in the virtual space by using the user data and the virtual space data, when the user requests the information of book-marking the particular location; and on user's part, storing the book-marking information when the information is received from the server so as to provide the information to the user when the user requests later.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram of a general networked computer environment in which the Internet is used;

FIG. 2 is a schematic block diagram of a book-marking client system 100 according to a preferred embodiment of the present invention;

FIG. 3 is a detailed block diagram showing the inside configuration of a snapshot client manager 130;

FIG. 4 is a detailed block diagram showing the inside configuration of a snapshot display 150;

FIG. 5 is a schematic block diagram of a book-marking server system 200 according to a preferred embodiment of the present invention;

FIG. 6 is a detailed block diagram showing the inside configuration of a location information manager 240;

FIGS. 7a and 7b show a flowchart for illustrating that a user book-marks a particular snapshot through the book-marking client system 100 and the book-marking server system 200;

FIG. 8 depicts a final virtual world snapshot meta data, which is stored by taking a snapshot of a virtual world screen;

FIG. 9 illustrates the virtual world snapshot meta data;

FIGS. 10a and 10b show a flowchart showing a moving from a thumbnail screen to a snapshot location by taking a snapshot;

FIG. 11 shows a book-mark list and a thumbnail screen marked with static information only; and

FIG. 12 illustrates an exemplary screen representing that a user is in a particular virtual world.

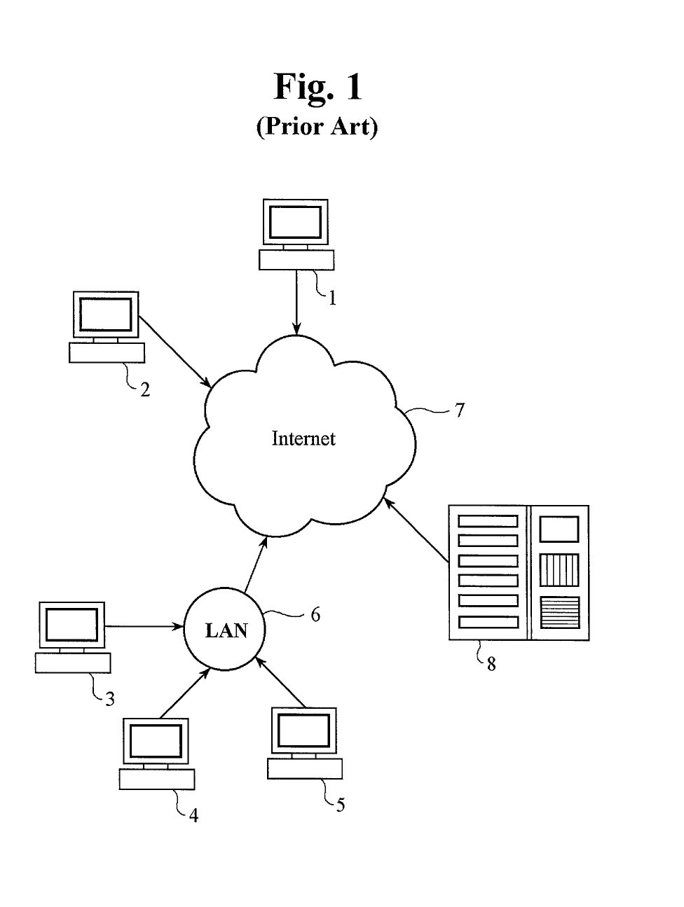

### DESCRIPTION OF THE PREFERRED EMBODIMENTS

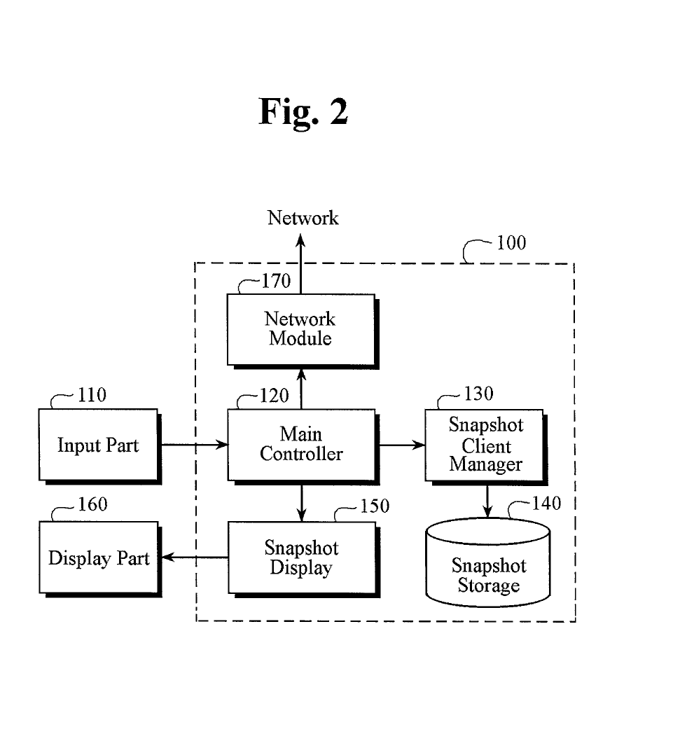

FIG. 2 is a block diagram of a book-marking system 100 that is installed in the client (user's computer) according to the present invention. As illustrated, the book-marking client system 100 includes a main controller 120, a snapshot client manager 130, a snapshot storage 140, a snapshot display part 150, and a network module 170.

The main controller 120 controls the snapshot client manager 130, the snapshot storage 140, the snapshot display part 150, and the network module 170 such that the snapshot client manager 130 such that they communicate with each other and also with external 3-D web servers for receiving snapshot files of bookmarked virtual worlds. Here, the snapshot means a virtual world without temporary objects such as avatars.

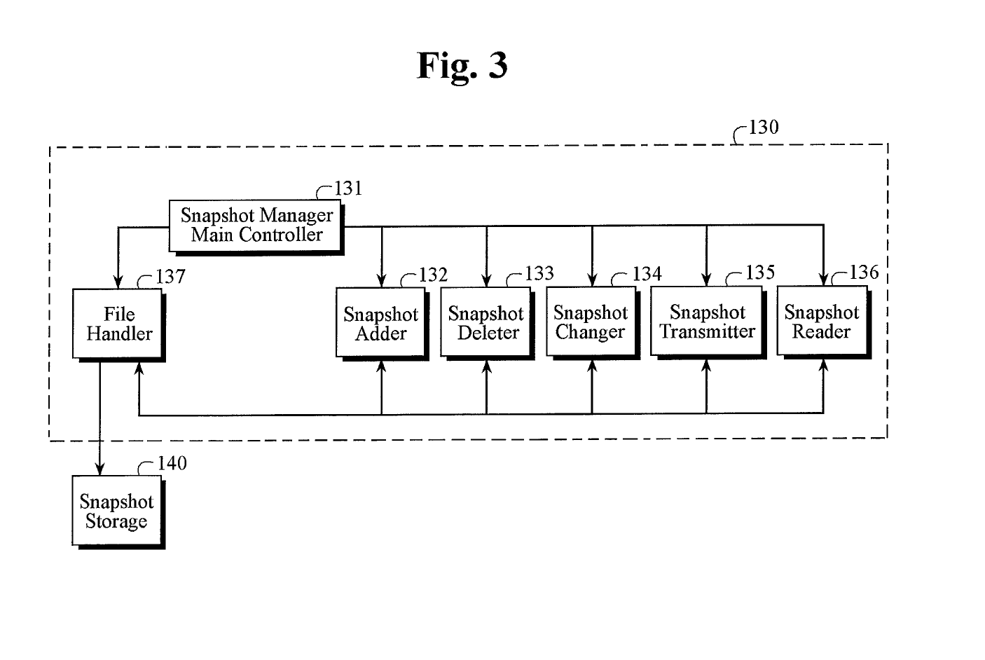

The snapshot client manager 130 stores, deletes, and transmits snapshots. FIG. 3 is a detailed block diagram of the snapshot client manager 130. As illustrated, it includes a snapshot manager main controller 131, a snapshot adder 132, a snapshot deleter 133, a snapshot changer 134, a snapshot transmitter 135, a snapshot handler 137, and a snapshot reader 136. The snapshot manager main controller 131 controls the flow of data between the remaining modules within the snapshot client manager 130. The file handler 137 acts for directly handling snapshot files stored in the snapshot storage 140. The snapshot reader 136 reads in snapshot files stored in the snapshot storage 140, and provides them to the snapshot manager main controller 131 and the file handler 137.

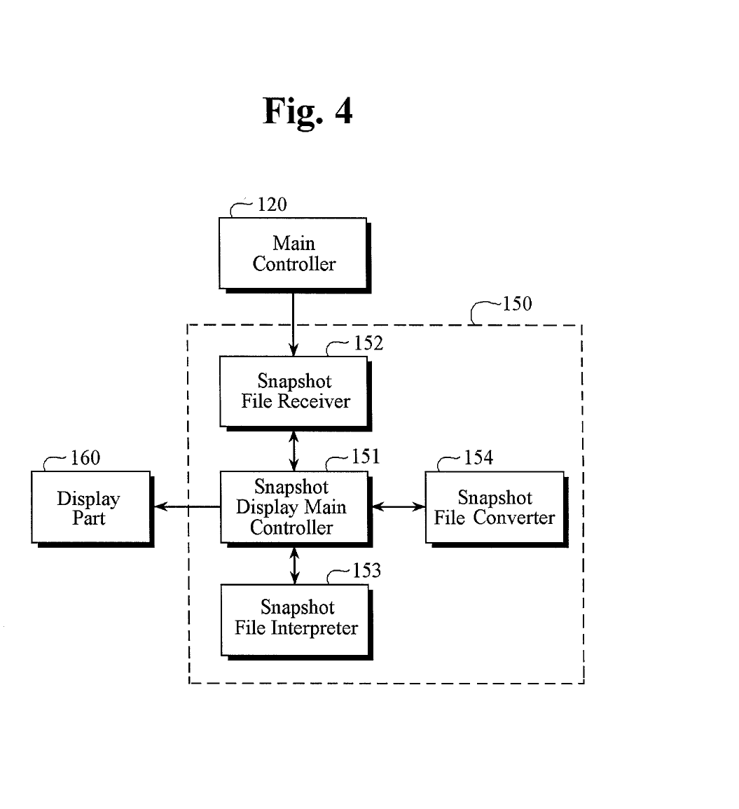

Again referring to FIG. 2, the snapshot display 150 receives snapshot information from the main controller 120 and converts the received snapshot into an image file format. FIG. 4 is a detailed block diagram of the snapshot display 150. As illustrated, it includes a snapshot display main controller 151, a snapshot file receiver 152, a snapshot file interpreter 153, and a snapshot file converter 154. The snapshot file display main controller 151 controls the other modules within the snapshot display 150. The snapshot file receiver 152 receives snapshot files from the main controller 120. The snapshot file interpreter 153 divides the received snapshot files into image files and location information such that they can be displayed on a user's monitor. The snapshot file converter 154 provides the display 160 with the information interpreted at the snapshot interpreter 153 by converting the information to the image format.

Next, it will be explained in detail hereinafter a book-marking system 200 according to the present invention, which is integrated in to a web server providing a three-dimensional virtual world.

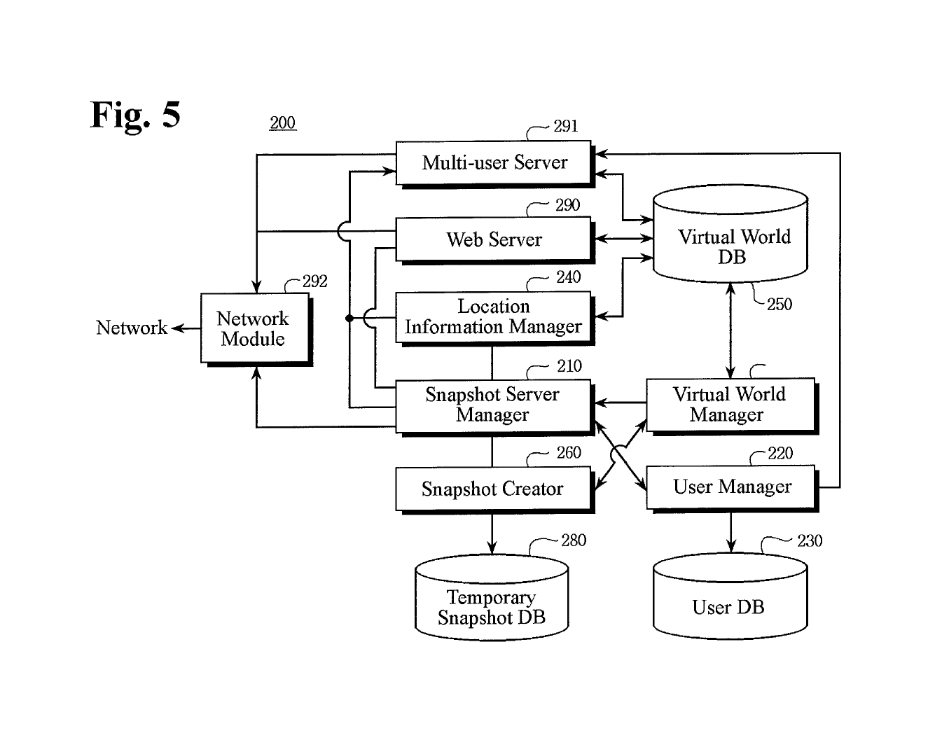

FIG. 5 is a block diagram of the book-marking server system 200 according to an embodiment of the present invention. As shown in the drawing, the book-marking server system 200 includes a snapshot server manager 210, a user manager 220, a user database (DB) 230, a location information manager 240, a virtual world DB 250, a snapshot creator 260, a virtual world manager 270, a temporary snapshot DB 280, a web server 290, a multi-user server 291, and a network module 292.

When a book-marking is requested from a book-marking client system 100, the snapshot server manager 210 controls the user manager 220, the location information manager 240, and the snapshot creator 260, thereby allowing the snapshot creator 260 to make a snapshot file of a virtual world the user indicated to bookmark, and then transmits the snapshot file to the main controller 120 of the book-marking client system 100 through the network module 292.

According to a request from the snapshot server manager 210, the user manager 220 extracts all user information and the user ID, and then transmits them to the snapshot server manager 220.

According to the request from the snapshot server manager 210, the location information manager 240 extracts all information on the user's location in the virtual world, and the ID of the virtual world, and then transmits them to the snapshot server manager 210. Further, the location information manager 240 provides all information about the user's location to any devices requiring the user's current location information.

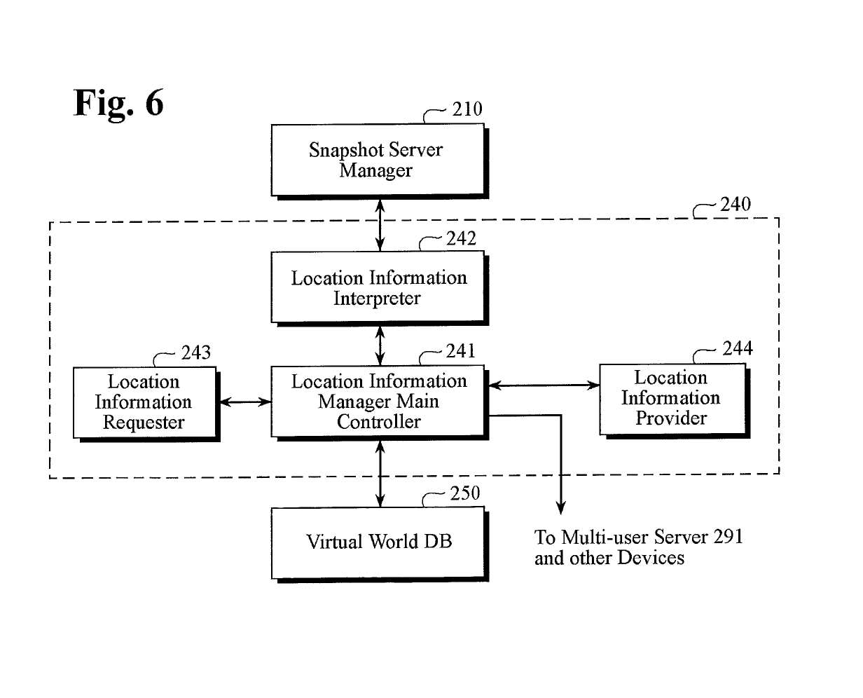

FIG. 6 is a detailed block diagram of the location information manager 240. As illustrated, the location information manager 240 includes a location information manager main controller 241, a location information interpreter 242, a location information requester 243, and a location information provider 244. The main controller 241 controls the flow of data between modules within the location information manager 240. When the location information manager 240 receives a snapshot file selected by the user through the snapshot server manager 210, the location information interpreter 242 extracts and interprets the location information from the snapshot file. The location information requester 243 receives the IP address of the user ID, and searches location information on the IP address, i.e., a virtual world category ID, a virtual world ID, location information, orientation information, from the virtual world DB 250. Afterwards, the location information requester 243 transmits the searched location information to the location information manager main controller 241. The location information provider 244 notifies the searched location information to those modules requiring the location information within the virtual space, e.g., interaction-related modules, that is, those modules used for communication between users over the virtual space, or between a server and a user.

Referring back to FIG. 5, according to the request from the snapshot server manager 210, the snapshot creator 260 receives information, relating to the background image of the virtual world, from the virtual world manager 270, creates a snapshot based on the received information, transforms the snapshot into a file that can be transmitted to the user, and stores the snapshot file in a temporary snapshot DB 280.

The world manager 270 takes information required for creating the snapshot files from the virtual world DB 250, and then transmits them to the snapshot creator 260 through the snapshot server manager 210.

The multi-user server 291 retrieves information of the currently logged-in users from the user manager 220, and moves the user to a location, where the snapshot files are stored, using the location information received from the location information manager 240. Then, the multi-user server 291 sends the moving result to all users within the user's virtual world.

From now on, the method for book-marking a particular snapshot in accordance with a preferred embodiment shown in the book-marking client system 100 and the book-marking server system 200 of the present invention.

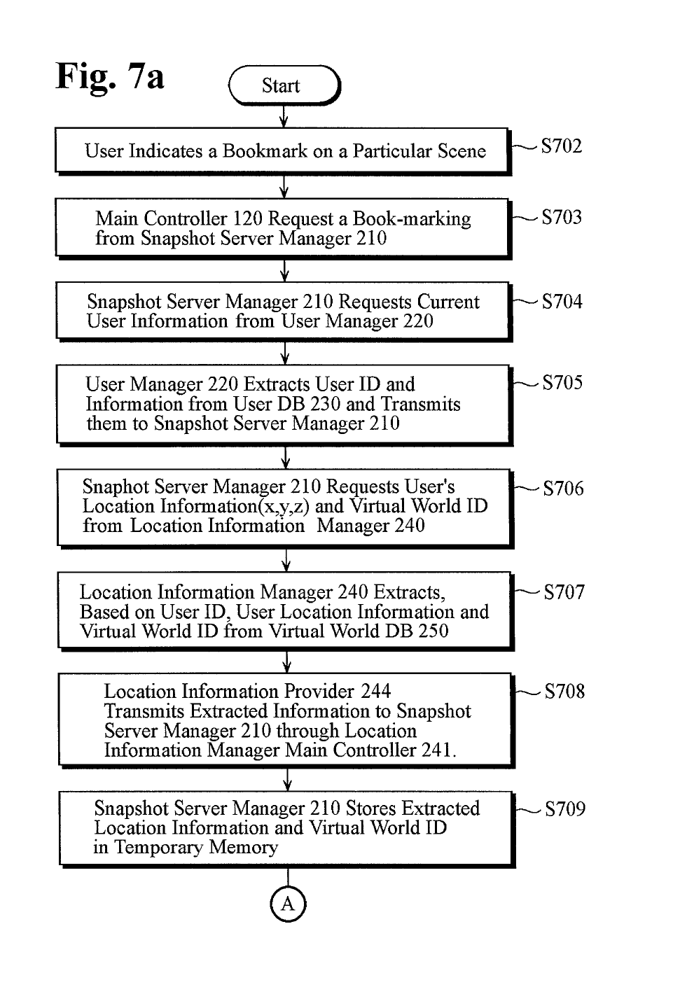

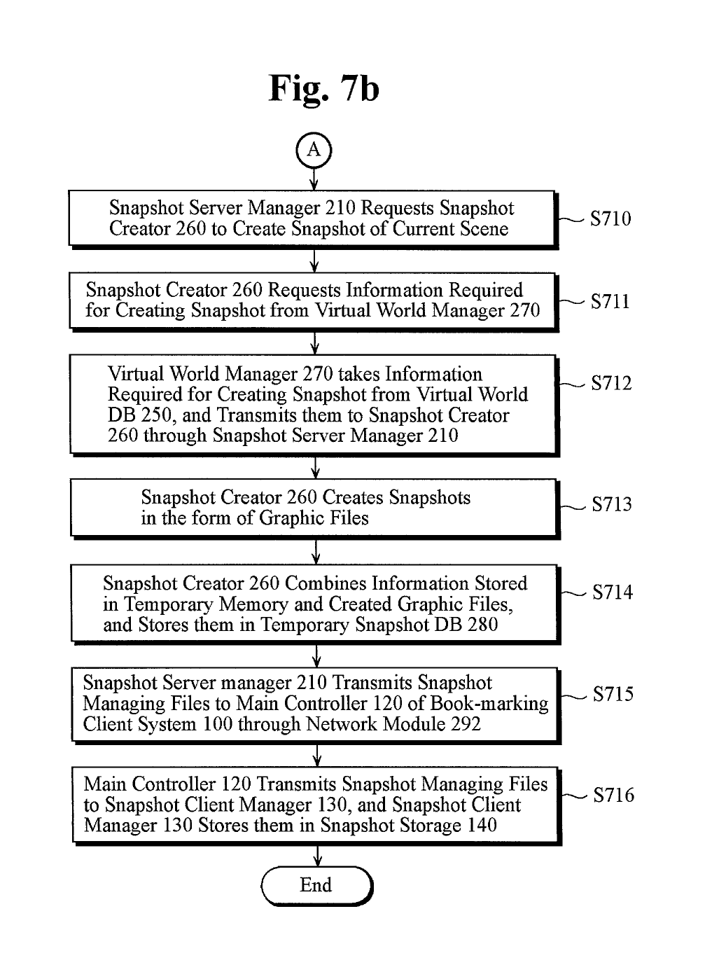

FIGS. 7a and 7b show a flowchart for explaining the steps for bookmarking a particular virtual world through the book-marking client system 100 and the book-marking server system 200.

The user navigating a virtual world indicates a bookmark on a particular scene in the virtual world (Step S702).

The indication of bookmarking is transmitted to the main controller 120 of the book-marking client system 100. The main controller 120 requests a book-marking from the snapshot server manager 210 of the book-marking server system 200 of the web server through the network module 170 (Step S703).

After receiving the book-marking request, the snapshot server manager 210 requests information of the user, such as the user ID and other information of the user provided for accessing the web server, from the user manager 220 (Step S704). Responding to the request, the user manager 220 transmits the user information by extracting them from the user DB 230, and transmits them to the snapshot server manager 210 (Step S705).

Afterwards, the snapshot server manager 210 requests the user's location information represented by the x, y, and z axes, and the virtual world ID of the user, from the location information manager 240 (Step S706). Responding to the request, based on the user ID, the location information manager 240 extracts the user's location information and the virtual world ID from the virtual world DB 250 (Step S707). Here, the user's location information is provided by the location information requester 243 of the location information manager 240 that retrieves the location information of user from the virtual world DB 250.

Next to Step S707, the location information provider 244 of the location information manager 240 transmits the extracted location information to the snapshot server manager 210 through the location information manager main controller 241 (Step S708). The snapshot server manager 210 receives the extracted location information and the virtual world ID, and stores them in a temporary memory (not shown) (Step S709).

Afterwards, the snapshot server manager 210 requests the snapshot creator 260 to create a snapshot of the current scene of the virtual world (Step S710). Responding to the request, the snapshot creator 260 requests information needed for creating the snapshot from the virtual world manager 270. (Step S711) In responsive to this, the virtual world manager 270 takes data required for creating the snapshot from the virtual world DB 250. In other words, the world manager 270 determines the current location of the user and takes the virtual world within the visible range of the user except for temporary objects. Then, the world manager 270 transmits them to the snapshot creator 260 through the snapshot server manager 210 (Step S712).

The snapshot creator 260 creates snapshots in the form of graphic files, which can be seen by the user, such as JPEG, GIF or PNG (Step S713).

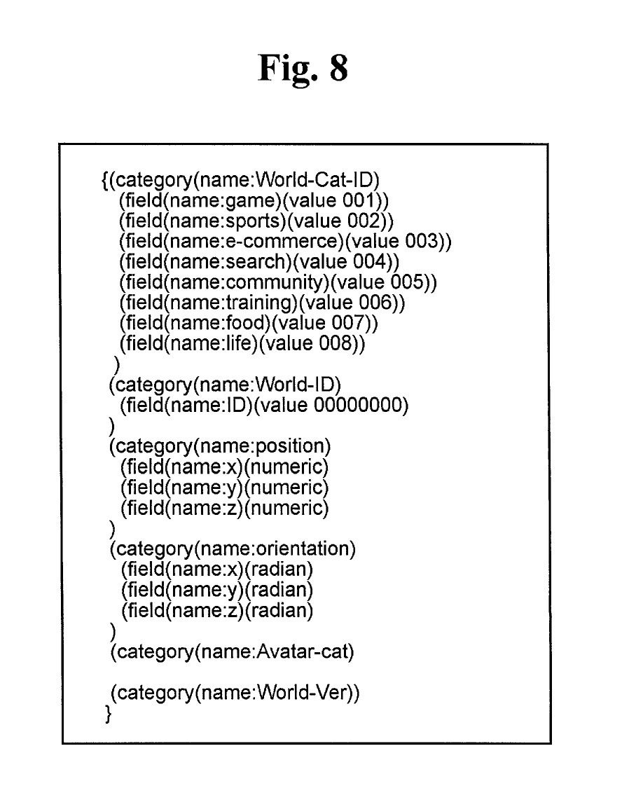

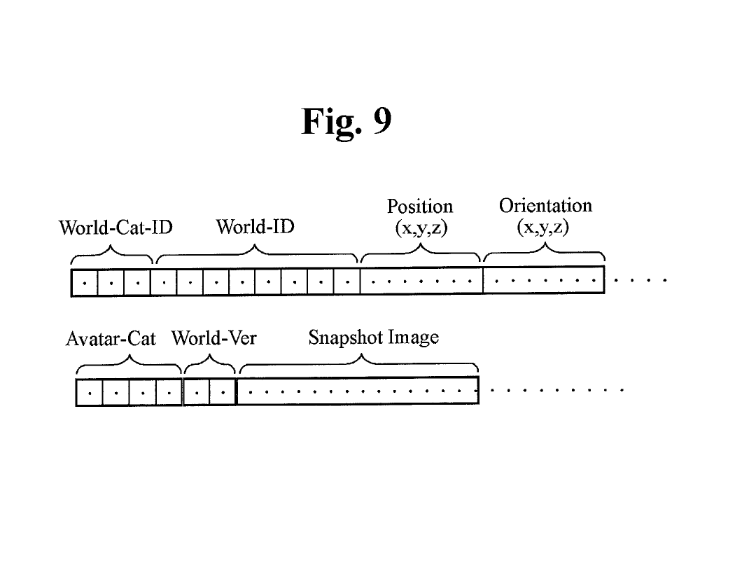

The snapshot creator 260 combines the data previously stored at the temporary memory and the graphic files into snapshot managing files that are transferable to the user, and then stores the snapshot managing files in the temporary snapshot DB 280 (Step S714). Those snapshot files are illustrated in FIGS. 8 and 9.

FIG. 8 depicts meta data a snapshot of a virtual world screen, and FIG. 9 illustrates the virtual world snapshot meta data in a transmission format. As illustrated in FIG. 9, the virtual world snapshot meta data may include a virtual world category ID World-Cat-ID of 3 bytes, a virtual world ID World-ID of 8 bytes, a location information Position (X, Y, Z), an orientation information Orientation (X, Y, Z), an avatar category Avatar-Cat of 4 bytes, a virtual world version World-Ver of 2 bytes, and snapshot images. Here, the numbers of bytes are exemplary lengths of the fields of data and can be greater or smaller depending on embodiments. The virtual world category ID World-Cat-ID is designed to classify virtual words according to there characteristics. For example, shopping malls, game centers, educational institutions such as colleges, public authorities such as the government, a theme park, religious facilities, which exist in real world, can be classified into categories and each given an ID. The virtual world ID World-ID represents an individual virtual world within a category. In the category of shopping mall, for instance, there may exist various individual virtual worlds such as a department store, a supermarket, a convenient store and so on. Here, each virtual world may further have sub-virtual world IDs representing a further break-down into smaller sections. For example, a department store in the virtual world may consist of many departments or of many floors. The location information Position (X, Y, Z) represents a user's coordinates in the 3-D virtual world with the center of a virtual world as origin.

The data as above can be extended always as meta data, and a meta-meta-definition language may be used to define the data. The orientation information Orientation (X, Y, Z) represents user's direction at the time of bookmarking. With this information, it is possible to display the user's avatar in the original orientation in the virtual world. In other words, an avatar in a virtual room will have only one position but can have many different orientations. It may be facing a different wall. Here, the orientation is the data structure recording the perspective of the avatar. This data structure has a radian value.

Because one can have more than one avatar to represent one in virtual worlds, the avatar category Avatar-Cat is set in order to place the same avatar back when the bookmarked virtual world is revisited. Furthermore, the virtual world version World-Ver represents the version of a virtual world since the virtual world can undergo changes resulting in many different versions.

Referring again to FIGS. 7a and 7b, at Step 715, the snapshot server manager 210 transmits the snapshot managing files to the main controller 120 of the book-marking client system 100 through the network module 292. Responding to this transmission, the main controller 120 transmits the snapshot managing files to the snapshot client manager 130, and the snapshot client manager 130 stores them in the snapshot storage 140 (Step 716). Inside the snapshot client manager 130, a pointer for the entire transmitted snapshot files or for a single file, i.e., the stored files' location on memory in the database, is transmitted to the snapshot adder 132 through the snapshot client manager main controller 131. Then, the snapshot adder 132 commands the file handler 137 to store the files, and, in response, the file handler 137 stores the files in the snapshot storage 140.

Next, how the user revisits a particular snapshot location.

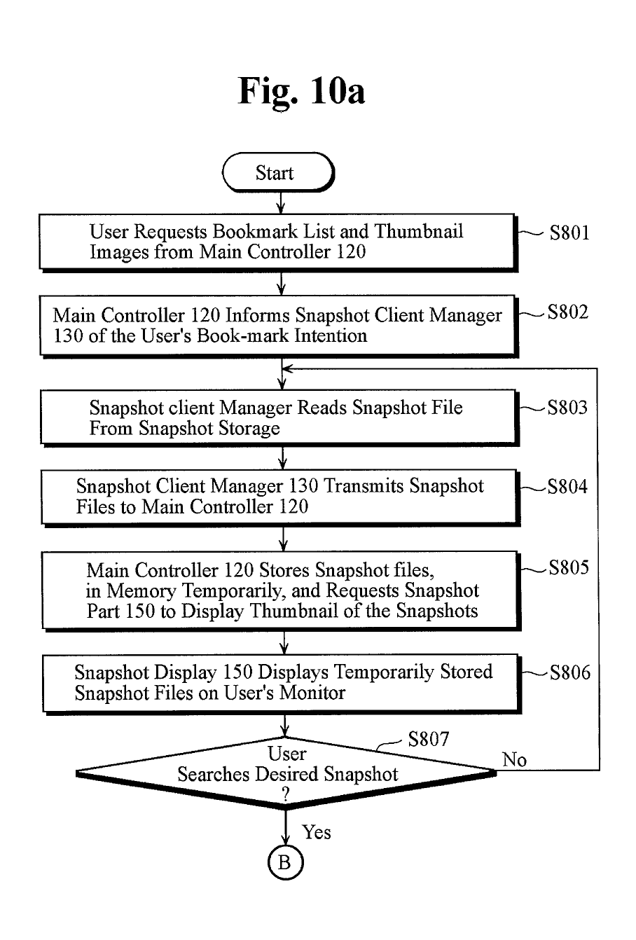

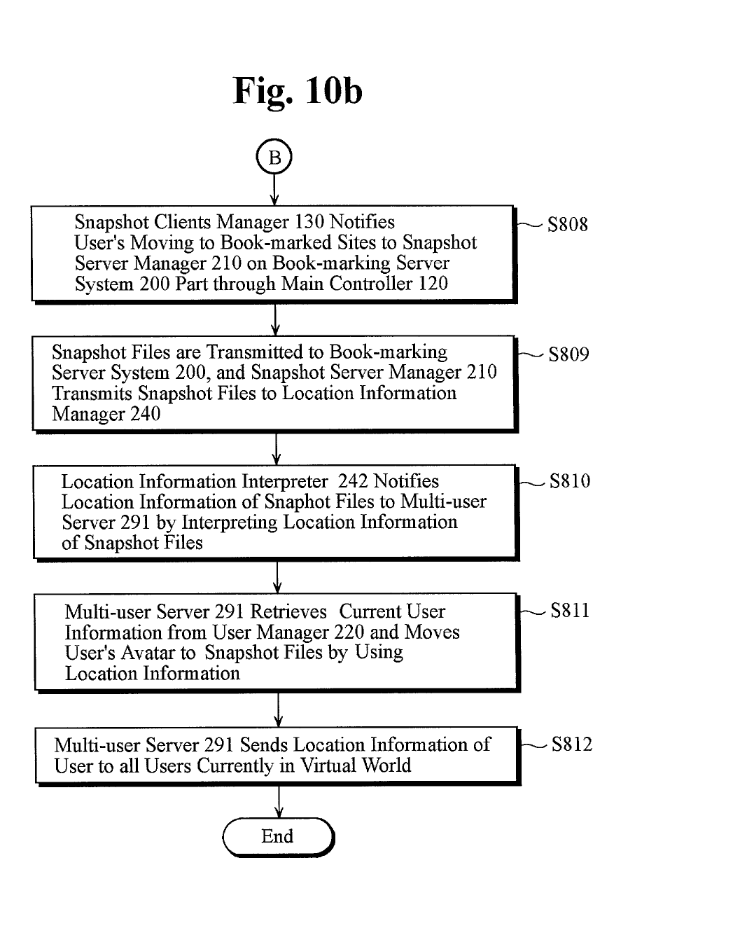

FIGS. 10a and 10b show a flowchart showing a revisit from a snapshot-thumbnail screen to a snapshot location.

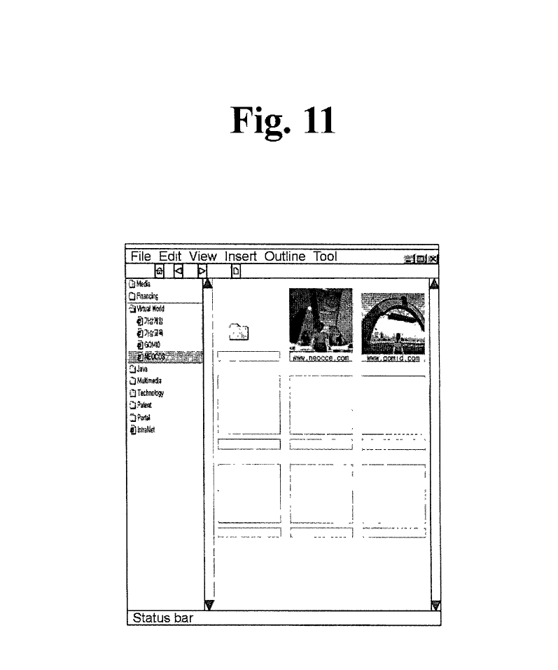

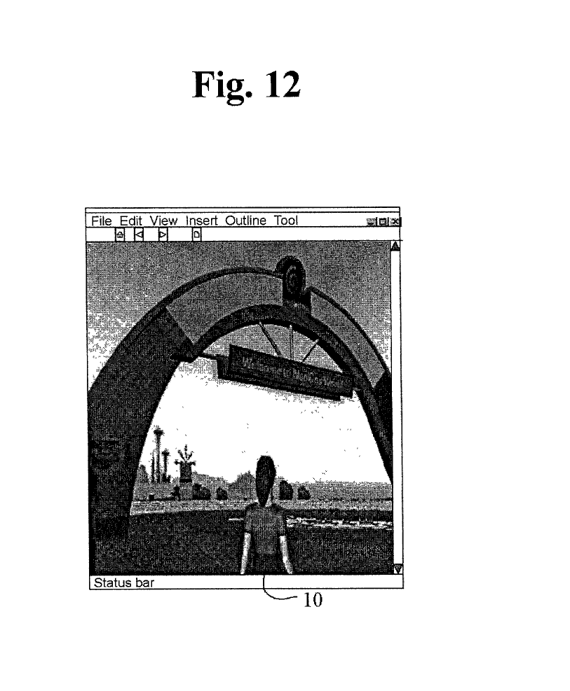

The user requests the main controller 120 to display a book-mark list and corresponding thumbnail images on the monitor (Step S801). An exemplary book-mark list and thumbnail images are shown in FIGS. 11 and 12. A tree-structured book-mark list is shown at left side of FIG. 11 while thumbnail snapshots are shown at right side. FIG. 12 illustrates a virtual world that was revisited after the user selected.

Referring to FIG. 10a, the main controller 120 at Step S802 informs the snapshot client manager 130 of the user's intention that the user activated a book-mark. Responding to this, the snapshot client manager 130 reads in the snapshot files from the snapshot storage 140 (Step S803). The snapshot client manager 130 does not read in all the files in the snapshot storage 140 but a selected files defined by the user.

The read-in snapshot files are transmitted to the main controller 120 by the snapshot file transmitter 135 of the snapshot client manager 130 (Step S804). Accordingly, the main controller 120 temporarily stores the snapshot files received from the snapshot client manager 130 at a temporary memory (not shown), and after that the main controller 120 requests the snapshot display 150 to display the thumbnails of the snapshots (Step S805). In responsive to this, the snapshot display 150 calls snapshot files which are stored at the temporary memory by the main controller 120, and displays them on the user's monitor (Step S806). More detailed description will follow with reference to FIG. 4. The snapshot files stored temporarily at the memory are received by the snapshot file receiver 152, and then they are transmitted to the snapshot file interpreter 153 through the snapshot display part main controller 151. Subsequently, the snapshot file interpreter 153 interprets the snapshots into a readable format on the user's monitor, and the interpreted information is transmitted to the snapshot display main controller 151. Afterwards, the main controller 120 transmits the interpreted information to the snapshot file converter 154, thereby displaying the interpreted information in an image format on the user's monitor under the control of the graphic kernel of the display part 160.

Referring to FIG. 10B, the user looks at the snapshots to select a virtual world (Step S807). If the user does not find desired snapshots, the process returns to Step S803.

When the user selects a particular snapshot at Step 807, the snapshot client manager 130 notifies to the snapshot server manager 210 of the book-marking server system 200 through the main controller 120 that the user wants to revisit a book-marked virtual world site. The snapshot file of the book-marked virtual world is also transmitted to the book-marking server system 200, and the snapshot server manager 210 transmits this file to the location information manager 240 (Step S809).

Responding to this, the location information interpreter 242 of the location information manager 240 interprets the location information in the snapshot file and informs the multi-user server 291 of the location information (Step S810).

The multi-user server 291 retrieves information of the user, e.g., the IP address, from the user manager 220. After this, the multi-user server 291 places the user's avatar on the snapshot file, using the location information received from the location information manager 240 (Step S811). Specifically, the user's avatar is inserted in the virtual world defined by the category ID, the virtual world ID, and the three-dimensional coordinates. After this, the three-dimensional virtual world may be displayed on the client. That is, when the server transmits the three-dimensional virtual world data to the client, the data includes the avatar's shape and location for the client to display them in the revised virtual world. Here, the data to be transmitted from the server to the client includes temporary objects such as other users' avatars as well as the background of the virtual world.

Meanwhile, if the scene of the virtual world has changed since the bookmarking, the avatar of the user is placed in a virtual world determined to be most similar to the intended virtual world. The multi-user server 291 simultaneously sends the location information of the user to all other users currently in the virtual world whose avatars are visible to the user. As a result, the user's avatar becomes displayed to all the other users of the users' visual field (Step S812).

With the present invention, as explained above, one can avoid storing unnecessary information such as others' avatars and temporary objects in a virtual world when one bookmarks the virtual world.

While the present invention has been shown and described with respective to the particular embodiments, it will be apparent to those skilled in the art that many changes and modifications may be mad without departing from the spirit and scope of the invention as defined in the appended claims.

What is claimed is:

1. A book-marking system on user's part for book-marking a particular location in a virtual space under the control of a server providing the virtual space on a network, comprising:
means for requesting to the server information required for book-marking through the network, when the user requests to book-mark for the particular location; wherein the information includes data for identifying the virtual space; data for indicating the particular location within the virtual space; and data on static objects except dynamic objects which vary with time within a predetermined distance from the particular location; and
means for storing the information when the information is received from the server so as to provide the information to the user when the user requests later.

2. The book-marking system on user's part of claim 1, further comprising means for visually displaying the data on static objects to the user.

3. The book-marking system on user's part of claim 2, wherein the means for displaying the data on static objects includes:
means for interpreting the data on static objects; and
means for converting the interpreted data on static objects to an image format, and displaying the image format data on a monitor of the user.

4. A book-marking system mounted to a server providing a virtual space on a network, for supporting a user to bookmark a particular location in the virtual space, comprising:
a first storage means for storing data of the user;
a second storage means for storing data of the virtual space; and
means for creating information of book-marking and transmitting the book-marking information to the user, after recognizing the particular location in the virtual space by using the user data and the virtual space data stored in the first and second storage means, when the user requests the information of book-marking the particular location,
wherein the book-marking information includes data for identifying the virtual space; data for indicating the particular location within the virtual space; and data on static objects except dynamic objects which vary with time within a predetermined distance from the particular location.

5. The book-marking system on server's part of claim 4, further comprising means for return-supporting for the user to return to the particular location corresponding to the book-marking information; wherein the return-supporting means includes:
means for extracting location information indicating the particular location by receiving the book-marking information from the user and interpreting the data for identifying the virtual space as well as the data for indicating the particular location within the virtual space; and
means for moving the user to the particular location by the use of the extracted location information.

6. The book-marking system on server's part of claim 5, wherein the moving means transmits data having both information of the dynamic objects and information of the static objects to the user.

7. The book-marking system on server's part of claim 5, further comprising a multicasting means for providing information related to the moving of the user to devices requiring the information related to the moving of the user, when the user moves to the particular location.

8. The book-marking system on server's part of claim 7, wherein the devices requiring the information related to the moving of the user are used to manage the objects within a predetermined distance from the particular location in the virtual space.

9. The system on server's part of claim 4, wherein the means for creating the information of book-marking includes:
means for extracting information for identifying the user from the first storage means;
means for extracting the data for identifying the virtual space and the data for indicating the particular location within the virtual space from the second storage means, based on the information for identifying the user;
means for extracting the data of the static objects from the second storage means, based on the data for identifying the virtual space and the data for indicating the particular location; and
means for creating the book-marking information by combining the data for identifying the virtual space, the data for indicating the particular location, and the data of the static objects.

10. A book-marking system to support a user to book-mark a particular location in a virtual space under the control of a server providing the virtual space on a network, comprising:
associated to user's part, means for requesting to the server information required for book-marking through the network, when the user requests to book-mark for the particular location; wherein the information includes data for identifying the virtual space; data for indicating the particular location within the virtual space; and data on static objects except dynamic objects which vary with time within a predetermined distance from the particular location;
associated to the server, a first storage means for storing data on the user;
associated to the server, a second storage means for storing data on the virtual space;
associated to the server, means for creating information of book-marking and transmitting the book-marking information to the user, after recognizing a particular location in the virtual space by using the user data and the virtual space data stored in the first and second storage means, when the user requests the information of book-marking the particular location; and
associated to user's part, means for storing the information when the information is received from the server so as to provide the information to the user when the user requests later.

11. A book-marking method on user's part for book-marking a particular location in a virtual space under the control of a server providing the virtual space on a network, comprising the steps of:
requesting to the server information required for book-marking through the network, when the user requests to book-mark the particular location, wherein the information includes data for identifying the virtual space; data for indicating the particular location within the virtual space; and data on static objects except dynamic objects which vary with time within a predetermined distance from the particular location; and
storing the information, when the information is received from the server so as to provide the information to the user when the user requests later.

12. The book-marking method on user's part of claim 11, further comprising the step of visually displaying the data on static objects to the user.

13. The book-marking method on user's part of claim 12, wherein the step of displaying includes the steps of:
interpreting the data on static objects; and
converting the interpreted data of the static objects to an image format, and displaying the interpreted data on a monitor of the user.

14. A book-marking method on server's part to support a user to book-mark a particular location in a virtual space, comprising the steps of:
storing data on the user;
storing data on the virtual space; and
creating information of book-marking and transmitting the book-marking information to the user, after recognizing the particular location in the virtual space by using the user data and the virtual space data, when the user requests the information of book-marking the particular location,
wherein the book-marking information includes data for identifying the virtual space; data for indicating the particular location within the virtual space; and data on static objects except dynamic objects which vary with time within a predetermined distance from the particular location.

15. The book-marking method on server's part of claim 14, further comprising the step of return-supporting for the user to return to the particular location corresponding to the book-marking information; wherein the return-supporting step includes the steps of:
extracting location information indicating the particular location by receiving the book-marking information from the user and interpreting the data for identifying the virtual space as well as the data for indicating the particular location within the virtual space; and
moving the user to the particular location by the use of the extracted location information.

16. The book-marking method on server's part of claim 15, wherein the moving step transmits data having both information of the dynamic objects and information of the static objects to the user.

17. The book-marking method on server's part of claim 15, further comprising the step of multicasting information related to the moving of the user to devices requiring the information related to the moving of the user, when the user moves to the particular location.

18. The book-marking method on server's part of claim 14, wherein the step for creating the information of book-marking includes the steps of:
extracting information for identifying the user from the user data;
extracting the data for identifying the virtual space and the data for indicating the particular location within the virtual space from the virtual space data, based on the information for identifying the user;
extracting the data of the static objects, based on the data for identifying the virtual space and the data for indicating the
creating the book-marking information by combining the data for identifying the virtual space, the data for indicating the particular location, and the data of the static objects.

19. A book-marking method to support a user to book-mark a particular location in a virtual space under the control of a server providing the virtual space on a network, comprising the steps of:
on user's part, requesting to the server information required for book-marking through the network, when the user requests to book-mark for the particular location; wherein the information includes data for identifying the virtual space; data for indicating the particular location within the virtual space; and data on static objects except dynamic objects which vary with time within a predetermined distance from the particular location;
on server's part, storing data on the user;
on server's part, storing data on the virtual space;
on server's part, creating information of book-marking and transmitting the book-marking information to the user, after recognizing a particular location in the virtual space by using the user data and the virtual space data, when the user requests the information of book-marking the particular location; and
on user's part, storing the book-marking information when the information is received from the server so as to provide the information to the user when the user requests later.
